(19) United States
(12) Patent Application Publication
(10) Pub. No.: US 2018/0152595 A1
(43) Pub. Date: May 31, 2018

(54) DOCUMENT READING APPARATUS

(71) Applicant: CANON KABUSHIKI KAISHA, Tokyo (JP)

(72) Inventors: Seiji Shibaki, Abiko-shi (JP); Satoshi Okawa, Toride-shi (JP)

(21) Appl. No.: 15/824,517

(22) Filed: Nov. 28, 2017

(30) Foreign Application Priority Data
Nov. 30, 2016 (JP) 2016-233502

(51) Int. Cl. H04N 1/401; H04N 1/407; H04N 1/10; H04N 1/00

(52) U.S. Cl. CPC H04N 1/401; H04N 1/4076; H04N 2201/0081; H04N 1/00761; H04N 1/1061; H04N 1/1013

(57) ABSTRACT

A document reading apparatus includes a calculation unit configured to calculate first shading data of a first sensor based on first measurement data acquired by the first sensor by reading a first reference member and calculate second shading data based on second measurement data acquired by a second reading sensor by reading a second reference member and profile data, and a verification unit configured to verify the profile data, and if the profile data is judged incorrect as a result of the verification, the calculation unit calculates the second shading data from the second measurement data acquired by the second reading sensor by reading the second reference member without using the profile data, and if the profile data is judged correct as a result of the verification, the calculation unit calculates the second shading data based on the second reference data and the profile data.

### BACKGROUND

### Field of the Disclosure

The present disclosure generally relates to document reading apparatuses.

### Description of the Related Art

A document reading apparatus configured to read an image of a document illuminates the document using a light source and reads the document. The direction in which the document is conveyed is called a sub-scanning direction, and a direction which is orthogonal to the sub-scanning direction is called a main-scanning direction. In the main-scanning direction, non-uniform illumination (non-uniform luminance) can occur. Shading correction is the processing performed to correct the non-uniform luminance. U.S. Pat. No. 5,909,287 discusses an apparatus which corrects a document image using shading data stored in a non-volatile memory if the shading data contains no checksum error. On the other hand, if the shading data stored in the non-volatile memory contains a checksum error, the apparatus reads a white reference document to generate shading data and corrects the document image. Specifically, if the shading data contains a checksum error, an operator places the white reference document so that a document reading apparatus reads the white reference document to generate shading data again. In this way, streaks and the like are less likely to be produced on the document image.

Meanwhile, a reading apparatus which simultaneously reads front and back surfaces of a document while the document is conveyed by a document conveying apparatus (automatic document feeder ((ADF)) has great document reading efficiency. In such a reading apparatus, a reading unit for reading the front surface and a reading unit for reading the back surface may each use shading data. If white reference plates instead of the white reference document are respectively provided to the front and back surfaces of a glass platen and shading data for the front surface and shading data for the back surface are to be generated by reading the white reference plates, the operator does not need to perform the operation of placing the white reference document, so usability improves. However, while the distance from the front surface of the document to the reading unit corresponds to the distance from the front-surface white reference plate to the reading unit, the distance from the back surface of the document to the reading unit does not correspond to the distance from the back-surface white reference plate to the reading unit. Thus, a problem arises that accuracy of shading correction performed by the reading unit which reads the back surface of the document is likely to decrease. It would be desirable for apparatuses that read documents to ameliorate or otherwise overcome accuracy concerns.

### SUMMARY

To address and/or otherwise enhance document reading, one or more aspects of the present disclosure stores profile data for absorbing the difference in distance in memory during the production of a document reading apparatus and measurement data of the white reference plate is converted into measurement data of the white reference document using the profile data. This realizes shading correction with great accuracy.

A document reading apparatus according to one or more aspects of the present disclosure is configured as follows.

According to an aspect of the present disclosure, a document reading apparatus includes a conveyor configured to convey a document, a first sensor configured to read in a first reading position a first surface of the conveyed document to output first image data, a first reference member configured to be read by the first sensor, a second sensor configured to read in a second reading position a second surface of the conveyed document to output second image data, a second reference member configured to be read by the second sensor, the second sensor being situated such that an optical path length from a position of the second sensor to a position of the second reference member is longer than an optical path length from the position of the second sensor to a position of the second reading position, a storage unit configured to store profile data for calculation of second shading data of the second sensor from second measurement data acquired by the second sensor by reading the second reference member, a calculation unit configured to calculate first shading data of the first sensor based on first measurement data acquired by the first sensor by reading the first reference member, and calculate the second shading data based on the second measurement data and the profile data, a shading correction unit configured to execute shading correction on the first image data based on the first shading data and execute shading correction on the second image data based on the second shading data, and a verification unit configured to verify the profile data, wherein in a case where the profile data is judged incorrect as a result of the verification, the calculation unit calculates the second shading data from the second measurement data without using the profile data, and in a case where the profile data is judged correct as a result of the verification, the calculation unit calculates the second shading data based on the second measurement data and the profile data.

Further features of the present disclosure will become apparent from the following description of exemplary embodiments with reference to the attached drawings.

### BRIEF DESCRIPTION OF THE DRAWINGS

FIG. 1 is a cross sectional view illustrating a document reading apparatus according to one or more aspects of the present disclosure.

FIG. 2 illustrates a control system according to one or more aspects of the present disclosure.

FIGS. 3A and 3B are perspective views illustrating the document reading apparatus according to one or more aspects of the present disclosure.

FIG. 4 is a flow chart illustrating a process of generating profile data according to one or more aspects of the present disclosure.

FIGS. 5A, 5B, and 5C illustrate measurement data and profile data according to one or more aspects of the present disclosure.

FIGS. 6A and 6B are a flow chart illustrating a process of reading a document according to one or more aspects of the present disclosure.

FIG. 7 illustrates a function of a central processing unit (CPU) according to one or more aspects of the present disclosure.

FIG. 8 illustrates a function of the CPU according to one or more aspects of the present disclosure.

### DESCRIPTION OF THE EMBODIMENTS

One or more aspects of the present disclosure will be described below with reference to the accompanying drawings.

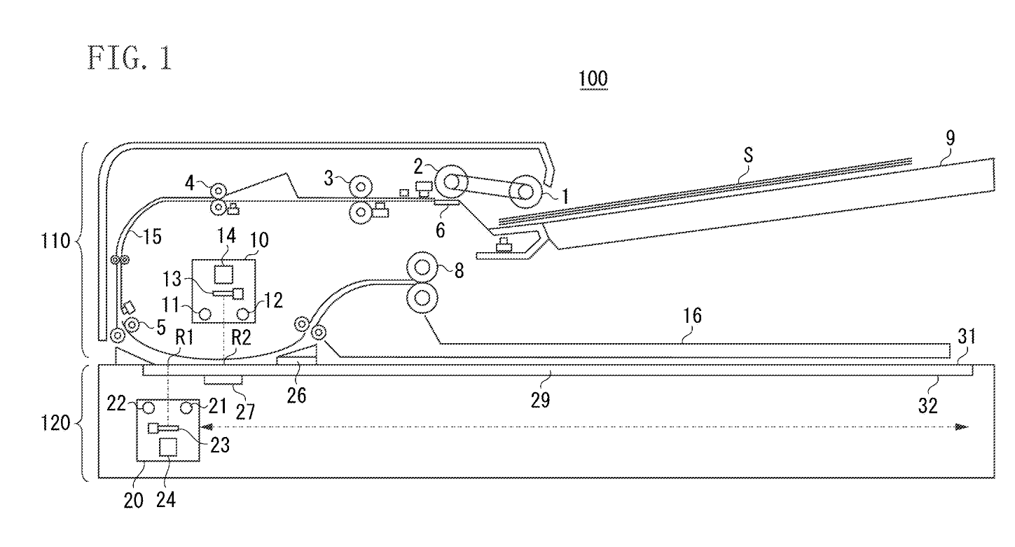

FIG. 1 is a cross sectional view illustrating an example of a document reading apparatus 100. The document reading apparatus 100 includes a document feeding device 110 and a document reading unit 120. The document feeding device 110 can also be referred to as an automatic document feeding unit (ADF).

### <ADF>

The document feeding device 110 includes a document tray 9 for stacking a document set S including one or more documents. A pickup roller 1 is brought into contact with the document set S to pick up a document included in the document set S and conveys the document downstream in the direction in which the document is conveyed. A separation roller 2 and a separation pad 6 which are situated downstream of the pickup roller 1 separate an uppermost document from the document set S and conveys the separated document. A pair of drawing rollers 3 situated downstream of the separation roller 2 and the separation pad 6 conveys the document and abuts the leading edge of the document against a registration roller 4. This causes the document to form a loop (flexure), and an incline of the document is corrected. Downstream of the registration roller 4 is situated a sheet feeding path 15 for guiding to a document glass platen 29 the document having been conveyed through the registration roller 4.

A sheet conveying roller 5 situated downstream of the sheet feeding path 15 conveys the document to a document reading position R1 of a front surface reading unit 20. The front surface reading unit 20 includes front surface light emitting diodes (LEDs) 21 and 22 which illuminate the front surface of the document conveyed on the document glass platen 29. A front surface lens array 23 forms an image of the document on a front surface image sensor 24. The front surface image sensor 24 receives reflection light from the front surface of the document and outputs an image signal representing the image of the front surface of the document. To simplify the description, one of the two surfaces of the document that is read by the front surface reading unit 20 will be referred to as “front surface” (first surface), and the other surface that is read by a back surface reading unit 10 will be referred to as “back surface” (second surface).

The sheet conveying roller 5 conveys the document to a document reading position R2 situated further downstream of the document reading position R1. The document reading position R2 is the position in which the back surface reading unit 10 reads the document. An optical system of the back surface reading unit 10 is focused on the document reading position R2. The back surface reading unit 10 includes back surface LEDs 11 and 12 which illuminate the back surface of the document conveyed on the document glass platen 29. A back surface lens array 13 forms an image of the document on a back surface image sensor 14. The back surface image sensor 14 receives reflection light from the back surface of the document and outputs an image signal representing the back surface of the document. The sheet conveying roller 5 passes to a sheet discharge roller 8 the document having passed through the document reading position R2. The sheet discharge roller 8 discharges the document to a sheet discharge tray 16.

### <Document Reading Unit>

The document reading apparatus 100 includes a sheet-through reading mode in which a document conveyed by the document feeding device 110 is read. The sheet-through reading mode is also referred to as a document feeding-reading mode and is capable of simultaneously reading the front and back surfaces of the document. The document reading apparatus 100 further includes a flat-bed reading mode in which a document placed on the document glass platen 29 is read. In the flat-bed reading mode, the document is not conveyed and, instead, the front surface reading unit 20 is moved in a sub-scanning direction to read the document. The document glass platen 29 can be a translucent member and can be made of a resin. The flat-bed reading mode can also be referred to as a fixed document reading mode.

A white reference member 26 for the front surface is fixed to a first surface 31 of the document glass platen 29. The first surface 31 is a surface that is exposed on the outside of a housing of the document reading unit 120 and is to be in contact with the document. One of the two surfaces of the white reference member 26 that is to be read by the front surface reading unit 20 is closely fixed to face the first surface 31. Thus, the first surface 31 to be read by the front surface reading unit 20 is less likely to be contaminated. The front surface reading unit 20 is moved in the sub-scanning direction to a position in which the white reference member 26 is readable, and reads the white reference member 26. The white reference member 26 extends along a main-scanning direction and functions as a positioning member which determines the position of the document in the main-scanning direction in the flat-bed reading mode. Specifically, an edge portion of the document is abutted against the white reference member 26 so that one side (shorter side/longer side) of the document becomes parallel to the main-scanning direction while the other side (longer side/shorter side) becomes parallel to the sub-scanning direction. The white reference member 26 includes a white member having uniform reflectance. Light output from the front surface LEDs 21 and 22 is reflected at the white reference member 26 to enter the front surface image sensor 24. However, the luminance of the light incident on the front surface image sensor 24 differs in each main-scanning position. Thus, output signals of the front surface image sensor 24 are corrected for each main-scanning position to adjust the reading luminance at each main-scanning position to a target luminance T. This correction is the shading correction. Execution of shading correction reduces non-uniform luminance across images acquired from the document and improves reproduction characteristics of halftones. A correction coefficient (shading data) for use in shading correction is generated by reading the white reference member 26 before the document is read.

A white reference member 27 for the back surface is fixed to a second surface 32 of the document glass platen 29. The second surface 32 is a surface that is on the inside of the housing of the document reading unit 120 and is not to be in contact with the document. One of the two surfaces of the white reference member 27 that is to be read by the back surface reading unit 10 is closely fixed to face the second surface 32, so the surface to be read by the back surface reading unit 10 is less likely to be contaminated. The white reference member 27 is situated on a straight line extending from the center of the back surface image sensor 14 toward the document reading position R2. The positional relationship among the back surface reading unit 10, the document reading position R2, and the white reference member 27 are fixed. Thus, the back surface reading unit 10 can read the white reference member 27 at any timing before the document passes through the document reading position R2. Further, it is no longer necessary to include a moving mechanism for moving the back surface reading unit 10 to a position in which the white reference member 27 is readable and a moving mechanism for moving the white reference member 27 to a position in which the back surface reading unit 10 can read the white reference member 27. This contributes toward size reduction of the document feeding device 110. Light output from the back surface LEDs 11 and 12 is reflected at the white reference member 27 to enter the back surface image sensor 14. However, the luminance of the light incident on the back surface image sensor 14 differs in each main-scanning position. Shading correction is to correct output signals of the back surface image sensor 14 for each main-scanning position to adjust the luminance at each main-scanning position to the target luminance T. Execution of shading correction reduces non-uniform luminance across images acquired from the document and improves reproduction characteristics of halftones. A correction coefficient (shading data) for use in shading correction is generated by reading the white reference member 27 before the document is read.

### <Control System>

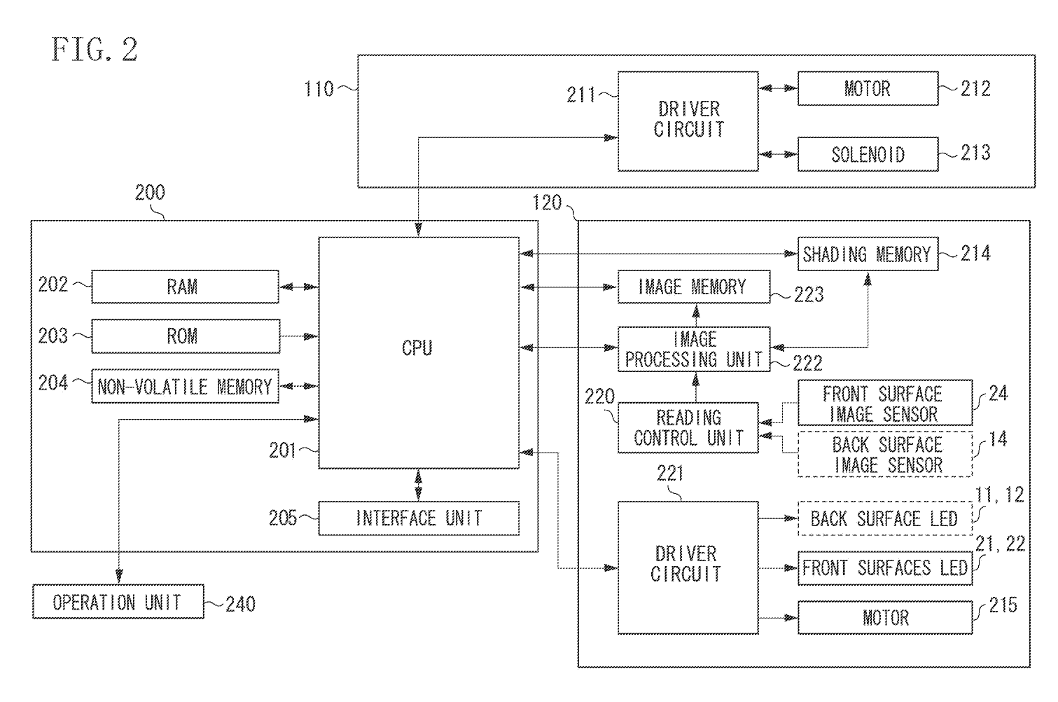

FIG. 2 illustrates a control system configured to control the document reading apparatus 100. While the back surface reading unit 10 is situated on the document feeding device 110 side in FIG. 1, since the back surface reading unit 10 is a function of the document reading unit 120, the elements in the back surface reading unit 10 are illustrated on the document reading unit 120 side in FIG. 2.

A controller unit 200 includes a central processing unit (CPU) 201, a random access memory (RAM) 202, a read-only memory (ROM) 203, a non-volatile memory 204, and an interface unit 205. The CPU 201, which may include one or more processors and one or more memories, is a controller which comprehensively controls the entire document reading apparatus 100. The RAM 202 is a random access memory used as a work area of the CPU 201. The ROM 203 is a read-only memory which stores control programs to be executed by the CPU 201, etc. The non-volatile memory 204 is a memory which is rewritable by the CPU 201 and stores profile data for use in generating shading data, verification data (e.g., checksum) for use in verification of profile data, etc. The verification data can be an error detecting code for use in detection of errors in profile data, etc. The interface unit 205 is a communication circuit connected to a local area network (LAN), a public line, etc. to communicate with external devices. The CPU 201 transmits document image data to the external devices and receives reading instructions from the external devices via the interface unit 205.

The units described throughout the present disclosure are exemplary and/or preferable modules for implementing processes described in the present disclosure. The modules can be hardware units (such as circuitry, a field programmable gate array, a digital signal processor, an application specific integrated circuit or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

The document feeding device 110 includes a driver circuit 211, a motor 212, and a solenoid 213. The driver circuit 211 is connected to an output port in the CPU 201. The driver circuit 211 is connected to the motor 212 and the solenoid 213. The motor 212 drives a plurality of rollers for conveying documents. The solenoid 213 moves the pickup roller 1 upward and downward. In response to a document reading instruction, the CPU 201 gives the driver circuit 211 an instruction to rotate the motor 212 and an instruction to operate the solenoid 213. The driver circuit 211 rotates the motor 212 and operates the solenoid 213 based on the instructions. If the solenoid 213 is turned on, the pickup roller 1 is moved downward. On the other hand, if the solenoid 213 is turned off, the pickup roller 1 is moved upward.

A motor 215 of the document reading unit 120 is connected to a driver circuit 221 and moves the front surface reading unit 20 in the sub-scanning direction or in the opposite direction to the sub-scanning direction. The driver circuit 221 is connected to the CPU 201 and drives the motor 215 according to an instruction form the CPU 201. The back surface LEDs 11 and 12 and the front surface LEDs 21 and 22 are also connected to the driver circuit 221. The driver circuit 221 performs control to turn on/off the back surface LEDs 11 and 12 and the front surface LEDs 21 and 22 and controls the amount of light of each of the back surface LEDs 11 and 12 and the front surface LEDs 21 and 22 according to an instruction form the CPU 201. Image signals output from the back surface image sensor 14 and the front surface image sensor 24 are input to a reading control unit 220. The reading control unit 220 converts the image signals into digital image data and outputs the digital image data to an image processing unit 222. The image processing unit 222 executes image processing, such as tone correction and shading correction, on the image data and writes to an image memory 223 the image data having undergone the image processing. The image processing unit 222 executes shading correction on the image data using shading data stored in a shading memory 214. The reading control unit 220 supplies power and outputs synchronization signals to the back surface image sensor 14 and the front surface image sensor 24. The back surface image sensor 14 and the front surface image sensor 24 output image signals in synchronization with the synchronization signals.

An operation unit 240 includes an output device, such as a liquid crystal display device, and an input device, such as a touch panel. The CPU 201 displays messages for the operator on the operation unit 240 and receives image reading instructions via the operation unit 240.

### <White Reference Member>

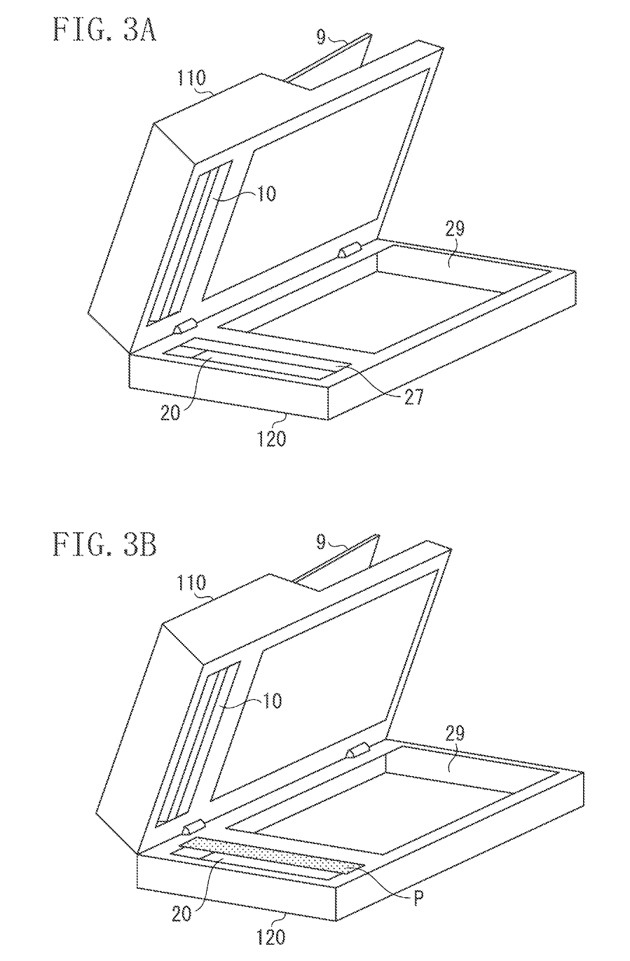

FIG. 3A is a perspective view illustrating the document reading apparatus 100 and illustrates the position of the white reference member 27 for the back surface. FIG. 3B is a perspective view illustrating the document reading apparatus 100 and illustrates the position of an outside white reference P used in place of the white reference member 27 for the back surface at the time of factory shipment and maintenance. The outside white reference P is a white reference member placed in the document reading position R2 on the document glass platen 29. The outside white reference P can be a plate-shaped white reference plate or a sheet-shaped white reference sheet.

The document reading apparatus 100 has two methods for measuring shading data for use in shading correction performed on a result of reading of the back surface of a document. One of the methods is a method using the white reference member 27 for the back surface which is attached to the document reading apparatus 100 as illustrated in FIG. 3A. The other one is a method using the outside white reference P as illustrated in FIG. 3B.

Inside White Reference

For a comparison with the outside white reference P, the white reference member 27 is referred to as an inside white reference. As illustrated in FIG. 3A, the document feeding device 110 is connected to the document reading unit 120 with hinges. While the white reference member 27 is read, the document feeding device 110 is closed to be in close contact with the document reading unit 120 not to be affected by outside light. The closed state is as illustrated in FIG. 1.

Meanwhile, as illustrated in FIG. 1, the distance from the back surface image sensor 14 to the document reading position R2 and the distance from the back surface image sensor 14 to the white reference member 27 differ by a distance d. The distance d is the thickness of the document glass platen 29. As described above, while the document is passed on the upper side of the document glass platen 29, the white reference member 27 is situated on the lower side of the document glass platen 29. The back surface lens array 13 is designed such that the document reading position R2 is focused with respect to the back surface image sensor 14. Specifically, the optical path length from the back surface image sensor 14 to the white reference member 27 is longer than the optical path length from the position of the back surface image sensor 14 to the document reading position R2. Thus, the white reference member 27 becomes slightly defocused. This can lead to decreased accuracy of shading correction in the case in which only measurement data of the white reference member 27 is used, compared to the case in which the outside white reference P is used. This problem does not arise with respect to front surface shading correction. Since the white reference member 26 for the front surface is situated on the upper side of the document glass platen 29, the distance from the front surface image sensor 24 to the document reading position R1 corresponds to the distance from the front surface image sensor 24 to the white reference member 26. Thus, in principle, no decrease in shading correction accuracy due to defocusing occurs. The shading correction accuracy is substantially the same in meaning as shading data generation accuracy.

As illustrated in FIG. 3B, an operator who is a manufacturer or maintenance worker places the outside white reference P on the document glass platen 29 and closes the document feeding device 110 with respect to the document glass platen 29. After the measurement (reading) of the outside white reference P is completed, the operator removes the outside white reference P from the document glass platen 29. The distance from the back surface image sensor 14 to the document reading position R2 corresponds to the distance to the outside white reference P, so shading data accuracy improves, and shading correction accuracy also improves relatively.

The necessity for the operator to place the outside white reference P on the document glass platen 29 each time a document is read impairs usability. Thus, the number of times the measurement is executed using the outside white reference P is desirably reduced to a minimum, e.g., one time during the manufacture of the document reading apparatus 100. The document reading apparatus 100 according to the present exemplary embodiment reads both the outside white reference P and the white reference member 27 and stores in the non-volatile memory 204 profile data indicating the ratio between the reading results. In response to a document reading instruction, the document reading apparatus 100 reads the white reference member 27 and obtains data (estimation data or conversion data) corresponding to the result of reading of the outside white reference P from the result of reading of the white reference member 27 and the profile data. Then, the document reading apparatus 100 uses the obtained data to obtain shading data for use in shading correction, stores the shading data in the shading memory 214, and executes shading correction. In this way, shading correction with high accuracy is realized without using the outside white reference P every time. Furthermore, usability also improves.

In conventional techniques, damaged shading data has been a problem. If profile data is damaged, shading correction accuracy can decrease. Data can be damaged by a breakdown of the non-volatile memory 204, overwriting of profile data with data containing an error, or replacement of a substrate on which the non-volatile memory 204 is mounted. While damage to data is detectable based on a checksum, etc., there are cases in which damage to data is undetectable. For example, profile data generated from measurement data containing an error is substantially damaged data. In such a case, errors are undetectable even if a checksum is used. If such a problem is overcome, a decrease in shading correction accuracy is prevented.

### <Profile Data Generation>

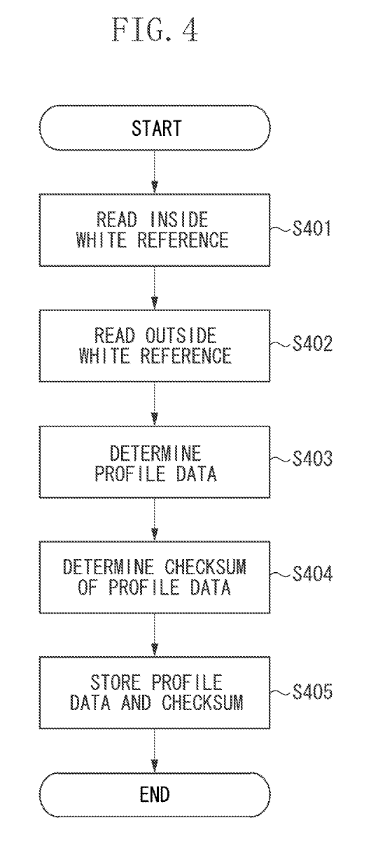

FIG. 4 is a flow chart illustrating a process of generating profile data. The process is executed, for example, during the manufacture of the document reading apparatus 100, during the replacement of parts including the non-volatile memory 204, or when non-uniform luminance due to shading occurs in the document reading result. In response to an instruction to execute the process of generating profile data from the operation unit 240, the CPU 201 starts the process. The CPU 201 can display on the operation unit 240 a special menu for manufacturers or maintenance workers to receive an instruction to start the process. Further, the CPU 201 can display on the operation unit 240 an operation menu for general users to receive an instruction to start the process.

In step S401, the CPU 201 reads the white reference member 27 which is the inside white reference for the back surface. For example, the CPU 201 instructs the driver circuit 221 to cause the back surface LEDs 11 and 12 to emit a predetermined amount of light. The CPU 201 instructs the reading control unit 220 to activate the back surface image sensor 14 to execute reading. The reading control unit 220 generates measurement data of each main-scanning position, which is a result of reading of the white reference member 27, and passes the generated measurement data to the CPU 201. The CPU 201 stores in the RAM 202 the measurement data of each main-scanning position. In this step, measurement data is acquired for 5184 main-scanning positions (pixels). A variable for storing the measurement data is In, where n is a main-scanning position. Accordingly, the RAM 202 stores measurement data I1 to I5184. The measurement data can also be referred to as a measurement result, reading data, reading result, etc.

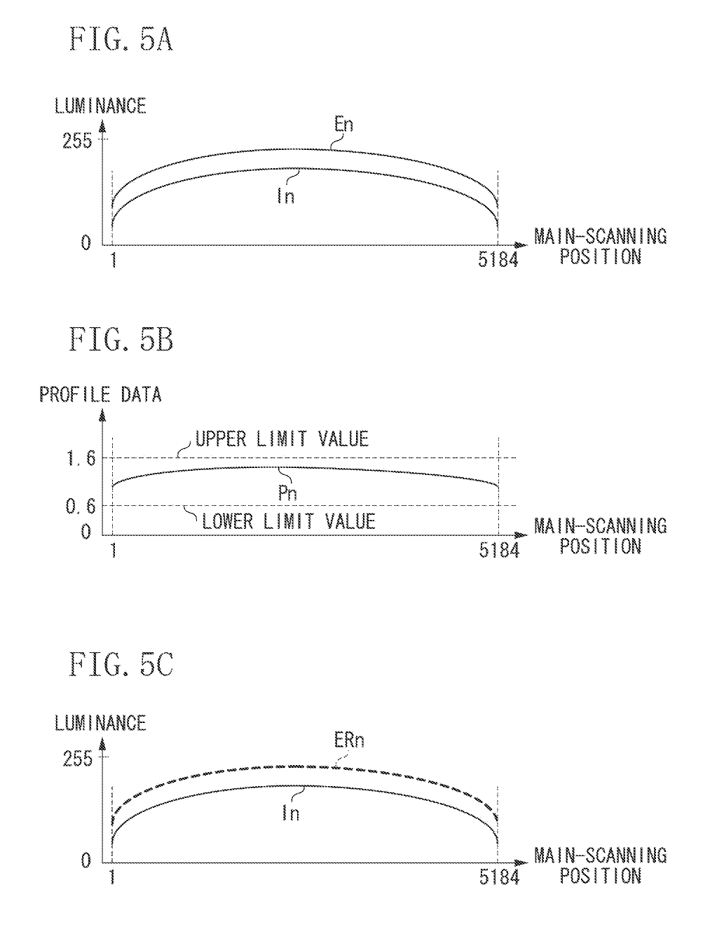

FIG. 5A illustrates an example of the measurement data of each main-scanning position with respect to the white reference member 27. The vertical axis represents the luminance value (8 bits), and the horizontal axis represents the main-scanning position. As illustrated in FIG. 5A, non-uniform luminance originating from light distribution characteristics of the back surface LEDs 11 and 12 occurs.

In step S402, the CPU 201 reads the outside white reference P. The CPU 201 can display on the operation unit 240 a message to prompt the operator to place the outside white reference P on the document glass platen 29. At the press of a start button of the operation unit 240, the CPU 201 instructs the driver circuit 221 to cause the back surface LEDs 11 and 12 to emit a predetermined amount of light. The CPU 201 instructs the reading control unit 220 to activate the back surface image sensor 14 to execute reading. The reading control unit 220 generates measurement data of each main-scanning position, which is a result of reading of the outside white reference P, and passes the generated measurement data to the CPU 201. The CPU 201 stores in the RAM 202 the measurement data of each main-scanning position. In this step, measurement data is also acquired for 5184 main-scanning positions. A variable for storing the measurement data is En. In the present exemplary embodiment, n is a variable which represents the main-scanning position and is a value of 1 to 5184. Accordingly, the RAM 202 stores measurement data E1 to E5184. FIG. 5A also illustrates an example of measurement data of each main-scanning position with respect to the outside white reference P. As illustrated in FIG. 5A, non-uniform luminance originating from light distribution characteristics of the back surface LEDs 11 and 12 occurs also occurs with respect to the outside white reference P. The measurement data with respect to the outside white reference P exceeds the measurement data with respect to the white reference member 27 in each main-scanning position. This is because the outside white reference P is situated closer to the back surface reading unit 10 than the white reference member 27 is.

In step S403, the CPU 201 determines profile data Pn based on the measurement data En of the white reference P and measurement data In of the white reference member 27, and stores the profile data Pn in the non-volatile memory 204. For example, the CPU 201 acquires profile data P1 to P5184 by computation using formula (1).

Pn=En/In (1).

FIG. 5B illustrates an example of the profile data Pn for each main-scanning position. The vertical axis represents the profile data, and the horizontal axis represents the main-scanning position. FIG. 5B also illustrates an example of an upper limit value and a lower limit value of a range within which profile data is determined as being acceptable.

In step S404, the CPU 201 determines a checksum Csave of the profile data P1 to P5184. For example, the CPU 201 expresses the total value of the profile data P1 to P5184 in binary form and obtains the low 16 bits. In step S405, the CPU 201 stores the profile data Pn and the checksum Csave in the non-volatile memory 204.

### <Shading Correction>

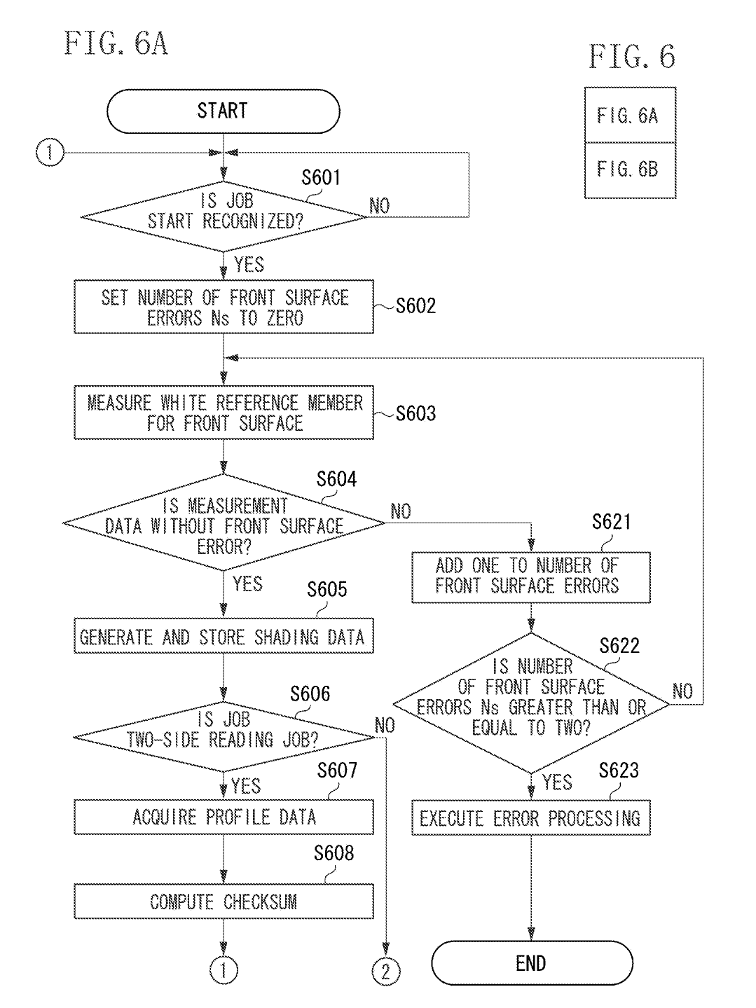

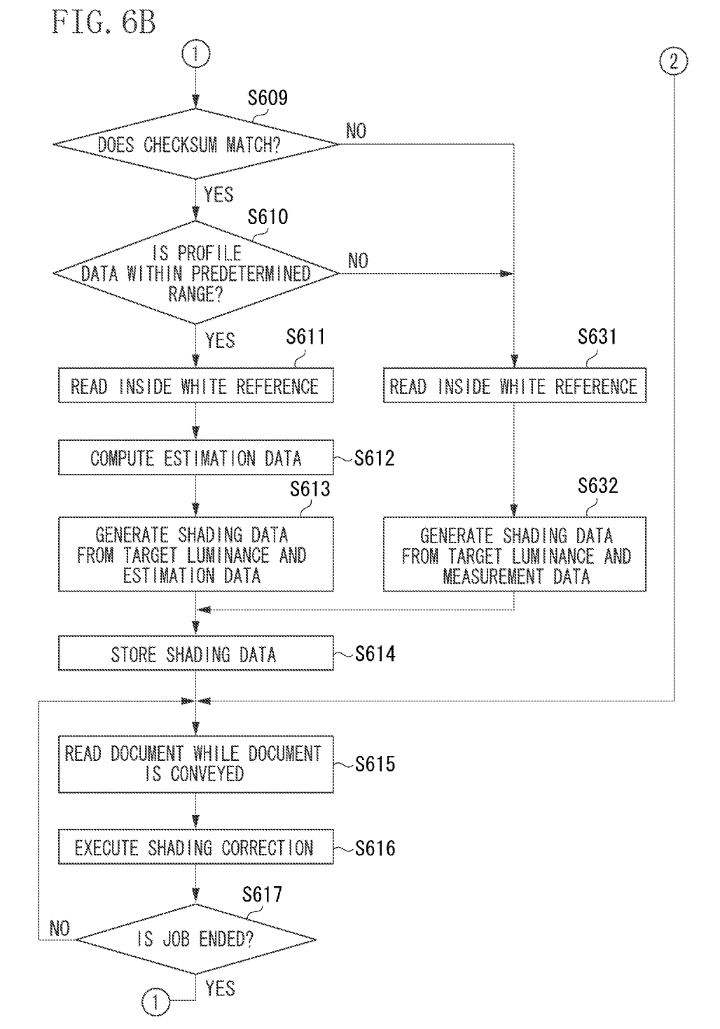

FIGS. 6A and 6B are a flow chart illustrating a process of reading a document by the sheet-through method. In step S601, the CPU 201 waits for a job start. If a document reading instruction is input via the operation unit 240 while a document is on the document tray 9, the CPU 201 recognizes a job start (YES in step S601), and the processing proceeds to step S602. The document tray 9 can include a document sensor for detecting the placement of a document on the document tray 9. In step S602, the CPU 201 sets the number of front surface errors Ns to zero. The number of front surface errors refers to the number of times shading data for the front surface is unsuccessfully generated, e.g., the measurement data of the white reference member 26 is not within a predetermined range.

In step S603, the CPU 201 executes measurement of the white reference member 26 for the front surface. The CPU 201 instructs the driver circuit 221 to cause the front surface LEDs 21 and 22 to emit a predetermined amount of light. Further, the CPU 201 drives the motor 215 via the driver circuit 221 to move the front surface reading unit 20 to the position immediately below the white reference member 26. Further, the CPU 201 instructs the reading control unit 220 to activate the front surface image sensor 24 to execute reading. The reading control unit 220 generates measurement data of each main-scanning position, which is a result of reading of the white reference member 26, and passes the generated measurement data to the CPU 201. The CPU 201 stores in the RAM 202 the measurement data of each main-scanning position. The front surface reading unit 20 can read the white reference member 26 while moving. For example, the CPU 201 can move the front surface reading unit 20 being at rest in a standby position to a movement start position and then move the front surface reading unit 20 from the movement start position to the position immediately below the white reference member 26.

In step S604, the CPU 201 judges whether the measurement data is without a front surface error. The front surface error indicates that the measurement data of the white reference member 26 is erroneous. For example, the CPU 201 can judge whether the measurement data contains data that is less than a predetermined threshold value. In the case in which measurement data (luminance level) is expressed as 8-bit data, a possible range of the measurement data is 0 to 255. It is assumed that the level of measurement data of the white reference member 26 is about 200. Therefore, if there is measurement data less than 100 which is a threshold value, the CPU 201 judges that there is a front surface error. The threshold value is predetermined by experiment, simulation, etc. If the threshold value is set close to the assumed luminance level, image quality improves, but the probability of erroneous detection also increases. Thus, the threshold value is selected in view of high image quality and probability of erroneous detection. If the CPU 201 judges that there is a front surface error (NO in step S604), the processing proceeds to step S621. In step S621, the CPU 201 adds one to the number of front surface errors Ns. In step S622, the CPU 201 judges whether the number of front surface errors Ns is greater than or equal to a threshold value (e.g., 2). If the number of front surface errors Ns is two or greater (YES in step S622), the processing proceeds to step S623. On the other hand, if the number of front surface errors Ns is not greater than or equal to two (NO in step S622), the processing proceeds to step S603, and the measurement of the white reference member 26 is executed again.

In step S623, the CPU 201 executes error processing. For example, the CPU 201 judges that the document reading apparatus 100 contains an error, and turns off the loads such as the motor 215 and the front surface LEDs 21 and 22 to stop reading the document. Further, the CPU 201 displays on the operation unit 240 a message indicating the error. As to the contents of the message, for example, a message to prompt the user to order repair service, such as “Error 1234 has occurred. Please turn it off and contact the service center.”, can be displayed. In step S604, if the CPU 201 judges that there is no front surface error (YES in step S604), the processing proceeds to step S605.

In step S605, the CPU 201 sets the shading data for the front surface to the shading memory 214. For example, the CPU 201 reads from the RAM 202 the measurement data of each main-scanning position and generates shading data, which is a correction coefficient for each main-scanning position, from the measurement data and the target luminance T. Alternatively, the CPU 201 can compute shading data by dividing the target luminance T by the measurement data. Read document data of each main-scanning position is corrected using such shading data so that non-uniform luminance of the light source and non-uniform sensitivity of the image sensor are corrected.

In step S606, the CPU 201 judges whether the job is a two-side reading job. If the job is a two-side reading job (YES in step S606), the processing proceeds to step S607. On the other hand, if the job is a one-side reading job (NO in step S606), the processing proceeds to step S615.

In step S607, the CPU 201 acquires the profile data Pn stored in the non-volatile memory 204. In step S608, the CPU 201 computes a checksum for use in verification of whether the profile data Pn is in a correct state. The CPU 201 expresses the total value of the profile data P1 to P5184 in binary form and obtains a checksum Ccalc of the low 16 bits. In step S609, the CPU 201 judges whether the checksum Ccalc matches the checksum Csave read from the non-volatile memory 204. If the checksum Ccalc matches the checksum Csave (YES in step S609), the CPU 201 judges that the stored profile data is not damaged, and the processing proceeds to step S610. On the other hand, if the checksum Ccalc does not match the checksum Csave (NO in step S609), the CPU 201 judges that the profile data contains an error, and the processing proceeds to step S631.

In step S610, the CPU 201 judges whether the profile data Pn is within a predetermined range. The predetermined range refers to a range from the upper limit value to the lower limit value within which the profile data Pn is acceptable as profile data. If the CPU 201 finds profile data Pn that is not within the predetermined range (NO in step S610), the CPU 201 judges that an error occurred at the time of generating the profile data Pn, and the processing proceeds to step S631. If every one of the profile data Pn is within the predetermined range (YES in step S610), the CPU 201 judges that there is no error in the profile data Pn, and the processing proceeds to step S611. As illustrated in FIG. 5B, for example, the upper limit value can be 1.6, and the lower limit value can be 0.6. The upper limit value and the lower limit value are predetermined by adding or subtracting a margin based on the ratio between the result of reading of the white reference member 27 and the result of reading of the outside white reference P. For example, in a case in which the mean value of the profile data Pn is about 1.1 and an upper limit margin and a lower limit margin are each 0.5, the upper limit value is determined by adding the margin to the mean value.

1.1+0.5=1.6 (2).

The margin is predetermined based on experiment, simulation, etc. The smaller the margin is, the higher the image quality becomes. However, even dust attached to a portion of the front surface of the document glass platen 29 that is located immediately above the white reference member 27 increases the probability of erroneous detection of an error in the back surface reading unit 10. Thus, the margin is determined in view of a tradeoff between high image quality and erroneous detection. The lower limit value is obtained by subtracting the margin from the mean value.

1.1−0.5=0.6 (3).

In step S611, the CPU 201 reads the white reference member 27 for the back surface. This reading processing is similar to the processing performed in step S401. The acquired measurement data In is stored in the RAM 202. In step S612, the CPU 201 computes estimation data which is the measurement data estimated with respect to the outside white reference P. For example, the CPU 201 converts the measurement data In of the white reference member 27 into estimation data Ern based on the profile data Pn and step S611.

ERn=Pn×In (4).

Use of the estimation data Ern makes it possible to acquire shading data generated as if the shading data is generated using the outside white reference P. FIG. 5C illustrates the relationship between the measurement data In and the estimation data ERn acquired in step S611. The vertical axis represents the luminance, and the horizontal axis represents the main-scanning position. From a comparison between FIGS. 5C and 5A it is found that the estimation data Ern is close to the measurement data En of the outside white reference P.

In step S613, the CPU 201 generates shading data Sn for the back surface based on the target luminance T and the estimation data ER.

Sn=T/ERn (5).

For example, in a case in which the target luminance T is 220 and the estimation data ER1 is 200, the shading data S1 is 1.1. In step S614, the CPU 201 stores the shading data Sn for the back surface in the shading memory 214.

If the checksum Ccalc does not match the checksum Csave or if an error is found in the profile data Pn, the processing proceeds to step S631. In step S631, the CPU 201 reads the white reference member 27 and stores the measurement data In in the RAM 202. In step S632, the CPU 201 generates shading data Sn for the back surface based on the target luminance T and the measurement data In.

Sn=T/In (6)

In step S614, the CPU 201 stores in the shading memory 214 the shading data Sn obtained in step S613 or S632. The shading data Sn obtained in step S632 is lower in accuracy than the shading data Sn obtained in step S613. However, allowing such simple shading correction to be executed produces an advantage that the document reading can be continued.

In step S615, the CPU 201 reads the document while the document is conveyed. The CPU 201 causes the driver circuit 211 to drive the solenoid 213 for a predetermined period so that the pickup roller 1 is brought into contact with the document set S. Further, the CPU 201 causes the driver circuit 211 to drive the motor 212 so that various rollers including the pickup roller 1 are rotated to start conveying the document. The CPU 201 drives the motor 215 via the driver circuit 221 to move the front surface reading unit 20 to a position that is immediately below the document reading position R1. In the one-side mode, the CPU 201 turns on the front surface LEDs 21 and 22 and causes the front surface image sensor 24 to read the front surface of the document. In the two-side mode, the CPU 201 further turns on the back surface LEDs 11 and 12 and causes the back surface image sensor 14 to read the back surface of the document.

In step S616, the CPU 201 executes shading correction on read document data Rn using the shading data Sn stored in the shading memory 214. For example, the CPU 201 instructs the image processing unit 222 to execute shading correction. If the shading data Sn obtained in step S613 is used, highly-accurate shading correction is executed. If the shading data Sn obtained in step S632 is used, simple shading correction is executed. The back surface image sensor 14 and the front surface image sensor 24 read a document one line by one line, so shading correction is executed one line by one line. The number of pixels included in one line is, for example, 5184.

RAn=Sn×Rn (7).

RAn is read data (image data) of a pixel on which shading correction is executed. Shading correction is executed for the back surface and for the front surface.

In step S617, the CPU 201 judges whether the job is ended by judging whether the document remains on the document tray 9. If the document remains (NO in step S617), the processing proceeds to step S615, and the CPU 201 reads the next document and executes shading correction. On the other hand, if the document does not remain (YES in step S617), the CPU 201 ends the series of reading processing. For example, the CPU 201 turns off all the loads such as the motor 212, the front surface LEDs 21 and 22, and the back surface LEDs 11 and 12.

Use of the profile data generated in advance using the outside white reference P as described above improves shading correction accuracy. Further, the outside white reference P does not have to be read during the document reading, so the burden on the operator is reduced, and usability improves. Further, if profile data is damaged or incorrect profile data is stored, shading data is generated based on the inside white reference, and shading correction is executed, without prohibiting the reading operation. Thus, the operator can execute document reading, so usability improves.

### <Conclusion>

As described above with reference to FIGS. 1 and 2, the sheet conveying roller 5 and the motor 212 are examples of a conveying unit which conveys documents. The front surface reading unit 20 is an example of a first reading unit which reads a first surface of a document. The white reference member 27 for the front surface is an example of a first white reference member which is read by the front surface reading unit 20. The back surface reading unit 10 is an example of a second reading unit which reads a second surface of the document. The white reference member 27 for the back surface is an example of a second white reference member (the inside white reference) which is read by the back surface reading unit 10. Further, the white reference member 27 is situated at a greater distance from the back surface reading unit 10 than the distance from the back surface reading unit 10 to the document reading position R2 in which the back surface reading unit 10 reads documents. The non-volatile memory 204 is an example of a storage unit which stores the profile data Pn and the checksum Csave of the profile data Pn. The profile data Pn is data for converting a result of reading of the inside white reference into a result of reading of the outside white reference. The profile data Pn is generated according to the ratio between two pieces of data. One of the two pieces of data is the measurement data acquired by the back surface reading unit 10 by reading the outside white reference P, which is a third white reference member, placed on the document reading position R2 in which the back surface reading unit 10 reads documents. Further, the other data is the measurement data acquired by the back surface reading unit 10 by reading the white reference member 27.

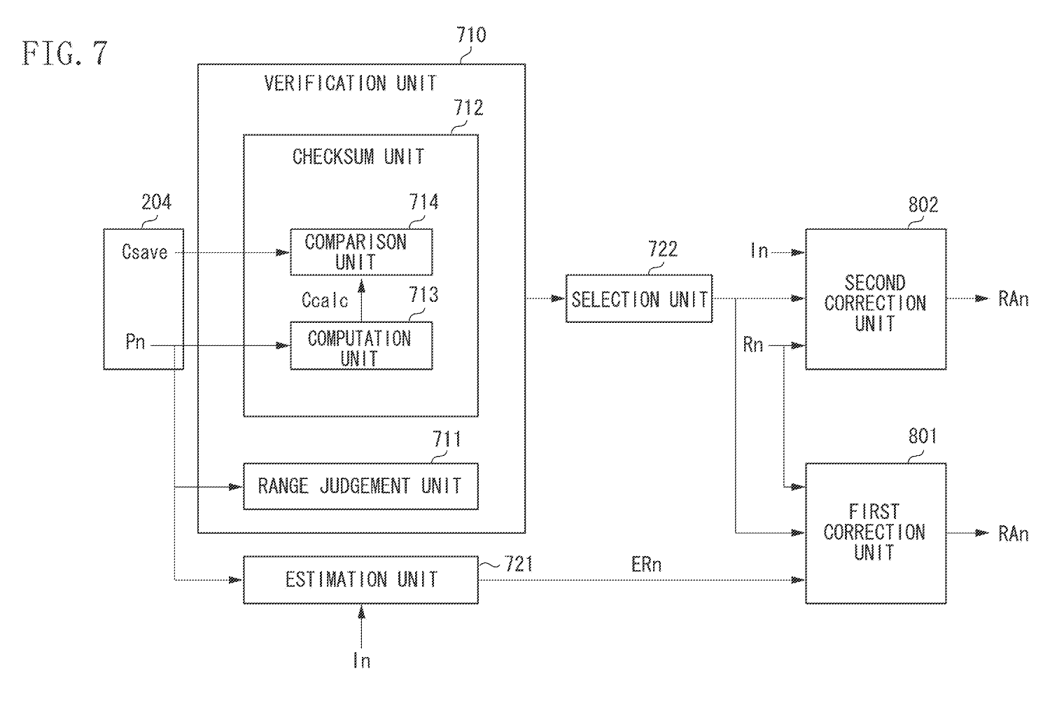

FIG. 7 illustrates functions realized by the CPU 201 by execution of a control program. The functions can partially or entirely be implemented by hardware such as circuitry, an application-specific integrated circuit (ASIC), a field programmable gate array (FPGA), or the like. The CPU 201 may function as a correction unit 700 which executes shading correction on the read document data Rn based on the shading data Sn stored in the shading memory 214. As described above, the correction unit 700 can be implemented in the image processing unit 222. The correction unit 700 may include a front surface correction unit 701 and a back surface correction unit 702. The front surface correction unit 701 may execute shading correction with respect to the front surface reading unit 20. The back surface correction unit 702 may execute shading correction with respect to the back surface reading unit 10. Specifically, the front surface correction unit 701 is an example of a first correction unit which may execute shading correction on image data of the first surface of the document read by the front surface reading unit 20, based on the shading data Sn generated by reading the first white reference member with the front surface reading unit 20. A verification unit 710 is an example of a verification unit which may verify the soundness of the profile data Pn stored in the non-volatile memory 204 based on the checksum Csave stored in the non-volatile memory 204. The back surface correction unit 702 may function as a second correction unit including at least two correction modes. The first correction mode may be a mode that is executed in the case in which the profile data Pn stored in the shading memory 214 is sound as described above in the description of steps S611 to S616. The first correction mode may be a mode in which shading correction is executed on image data of the second surface of the document read by the back surface reading unit 10 based on the shading data Sn. Especially, the shading data Sn may be generated based on the profile data Pn and the measurement data In generated by reading the white reference member 27. The second correction mode may be a mode that is executed in the case in which the profile data Pn is not sound. Specifically, the second correction mode is a simple correction mode in which shading correction may be executed on image data of the second surface of the document without using the profile data Pn. The second correction mode is a mode in which shading correction may be executed based on the shading data Sn generated by reading the white reference member 27 as described above in the description of steps S631 and S632. According to the present exemplary embodiment, if the profile data Pn is sound, highly-accurate shading correction using the profile data Pn is executed. On the other hand, if the profile data Pn is not sound, simple shading correction without the use of the profile data Pn is executed without prohibiting the document reading. In this way, usability improves.

A range judgement unit 711 of the verification unit 710 may function as a judgement unit which judges whether the profile data Pn is within the predetermined range. The verification unit 710 can judge that the stored profile data Pn is sound if the stored profile data Pn contains no checksum error and the profile data Pn is within the predetermined range. Use of profile data Pn containing a checksum error can cause streaks and the like on images on which shading correction is executed. Thus, occurrences of streaks and the like are reduced by not using the profile data Pn containing a checksum error. Further, although there is no checksum error, if the profile data Pn is erroneously generated, shading correction accuracy decreases. Thus, the profile data Pn is not used also in the case in which the profile data Pn is erroneously generated. In this way, shading correction accuracy improves.

The profile data Pn is data for absorbing a difference between the distance from the back surface reading unit 10 to the white reference member 27 and the distance from the back surface reading unit 10 to the outside white reference P. Specifically, the profile data Pn is a correction coefficient for correcting a difference in luminance between the measurement data acquired by the back surface reading unit 10 by reading the outside white reference P and the measurement data acquired by the back surface reading unit 10 by reading the white reference member 27.

The verification unit 710 includes a checksum unit 712 which may execute checksum-related processing. The checksum unit 712 includes a computation unit 713 and a comparison unit 714. The checksum unit 712 is an example of a detection unit which may detect a checksum error in the profile data Pn based on whether the checksum Ccalc matches the checksum Csave. The computation unit 713 is an example of a computation unit which may compute the checksum Ccalc of the profile data Pn stored in the non-volatile memory 204. The comparison unit 714 is an example of a comparison unit which may compare the checksum Ccalc computed from the profile data Pn stored in the non-volatile memory 204 to the checksum Csave stored in the non-volatile memory 204. If the checksum Ccalc matches the checksum Csave, the checksum unit 712 judges that the profile data Pn stored in the non-volatile memory 204 contains no checksum error. On the other hand, if the checksum Ccalc does not match the checksum Csave, the checksum unit 712 judges that the profile data Pn stored in the non-volatile memory 204 contains a checksum error.

The document glass platen 29 is an example of a flat translucent plate on which a document is placed. As illustrated in FIG. 1, the white reference member 26 is fixed to the first surface 31 on which a document is to be placed, among the first surface 31 and the second surface 32 of the document glass platen 29. The white reference member 27 is fixed to the second surface 32 of the document glass platen 29 on which no document is to be placed. Thus, the reading surfaces of the white reference member 26 and the white reference member 27 are less likely to be contaminated. However, the problem of distance described above occurs with respect to the white reference member 27.

As illustrated in FIG. 1, the first surface 31 of the document glass platen 29 includes a first reading region and a second reading region. A document conveyed by the document feeding device 110 does not pass through the first reading region, whereas the document conveyed by the document feeding device 110 passes through the second reading region. The white reference member 26 is situated between the first reading region and the second reading region. Specifically, the region of the first surface 31 of the document glass platen 29 that is on the left side of the white reference member 26 is the second reading region, and the region on the right side of the white reference member 26 is the first reading region. Further, the first reading region is a region where the front surface reading unit 20 reads a document placed on the first surface 31 of the document glass platen 29 while being moved.

As illustrated in FIG. 1, the white reference member 27 is situated in a position at which a straight line connecting the back surface reading unit 10 and the document reading position R2 intersects with the second surface 32 of the document glass platen 29. This makes it unnecessary to include a mechanism for moving one of the back surface reading unit 10 and the white reference member 27.

As illustrated in FIG. 2, the motor 212 is an example of a moving unit which may move the front surface reading unit 20 in the horizontal direction. In response to a document reading instruction, the motor 212 may move the front surface reading unit 20 to a first position in which the white reference member 26 is readable by the front surface reading unit 20. If the reading of the white reference member 26 by the front surface reading unit 20 is completed, the motor 212 may move the front surface reading unit 20 to a second position in which the first surface of the document conveyed by the document feeding device 110 is readable.

In FIG. 7, an estimation unit 721 has the function of generating the estimation data ERn. As described above in the description of step S612, the estimation unit 721 determines the estimation data ERn by converting the measurement data In of the white reference member 27 into the measurement data of the outside white reference P using the profile data Pn. A selection unit 722 selects one of the first correction mode and the second correction mode according to a result of verification of the profile data Pn. This corresponds to the selection of whether to supply the measurement data In of the white reference member 27 or the estimation data ERn to a generation unit 723 which generates shading data Sn. As described above in the description of steps S613 and S632, the generation unit 723 generates shading data Sn using the supplied measurement data and the target luminance T and stores the generated shading data Sn in the shading memory 214. The back surface correction unit 702 reads the shading data Sn for the back surface which is stored in the shading memory 214, executes shading correction on the read data Rn which is image data, and generates corrected reading data RAn.

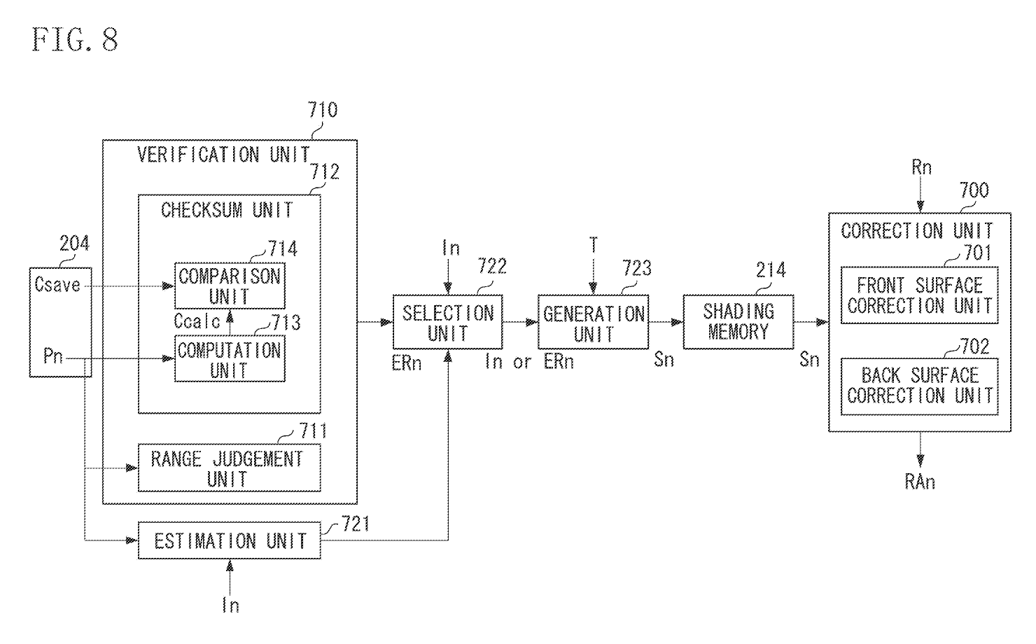

FIG. 8 illustrates functions of the CPU 201 that relate to shading correction. In FIG. 7, the generation unit 723 in FIG. 8, the shading memory 214, and the back surface correction unit 702 in FIG. 8 are replaced by a first correction unit 801 and a second correction unit 802. In FIG. 7, illustration of the front surface correction unit 701 is omitted. The first correction unit 801 corresponds to the first correction mode (detailed mode) described above. The second correction unit 802 corresponds to the second correction mode (simple mode). The first correction unit 801 may execute shading correction on the image data of the document read by the back surface reading unit 10 based on the shading data Sn. The shading data Sn is generated based on the profile data Pn stored in the non-volatile memory 204 and the measurement data In acquired by the back surface reading unit 10 by reading the white reference member 27. The second correction unit 802 may execute shading correction on the image data of the document read by the back surface reading unit 10 without using the profile data Pn based on the shading data generated by the back surface reading unit 10 by reading the white reference member 27. The selection unit 722 may select the first correction unit 801 if no checksum error is detected from the profile data Pn stored in the non-volatile memory 204 and if the profile data Pn stored in the non-volatile memory 204 is within the predetermined range. The selection unit 722 may select the second correction unit 802 if a checksum error is detected from the profile data Pn stored in the non-volatile memory 204 or if the profile data Pn stored in the non-volatile memory 204 is not within the predetermined range. In this way, even if a problem of the profile data Pn arises, the operator can execute the document reading. The profile data Pn is data of each of a plurality of main-scanning positions in the main-scanning direction which is orthogonal to the direction in which the document is conveyed. Further, the shading data Sn is data for reducing non-uniform luminance in each of the plurality of main-scanning positions.

While the checksums are used as verification data for the verification of errors in the profile data Pn in the above-described exemplary embodiment, any other verification data generated from the profile data Pn can be employed. Further, while the soundness of the profile data Pn is verified using both steps S609 and S610, only one of steps S609 and S610 can be used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors and one or more memories (e.g., central processing unit (CPU), micro processing unit (MPU)), and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-233502, filed Nov. 30, 2016, which is hereby incorporated by reference herein in its entirety.

What is claimed is:

1. A document reading apparatus comprising:
a conveyor configured to convey a document;
a first sensor configured to read in a first reading position a first surface of the conveyed document to output first image data;
a first reference member configured to be read by the first sensor;
a second sensor configured to read in a second reading position a second surface of the conveyed document to output second image data;
a second reference member configured to be read by the second sensor,
the second sensor being situated such that an optical path length from a position of the second sensor to a position of the second reference member is longer than an optical path length from the position of the second sensor to a position of the second reading position;
a storage unit configured to store profile data for calculation of second shading data of the second sensor from second measurement data acquired by the second sensor by reading the second reference member;
a calculation unit configured to calculate first shading data of the first sensor based on first measurement data acquired by the first sensor by reading the first reference member, and calculate the second shading data based on the second measurement data and the profile data;
a shading correction unit configured to execute shading correction on the first image data based on the first shading data and execute shading correction on the second image data based on the second shading data; and
a verification unit configured to verify the profile data,
wherein in a case where the profile data is judged incorrect as a result of the verification, the calculation unit calculates the second shading data from the second measurement data without using the profile data, and
in a case where the profile data is judged correct as a result of the verification, the calculation unit calculates the second shading data based on the second measurement data and the profile data.

2. The document reading apparatus according to claim 1, further comprising a transparent member provided in the first reading position and the second reading position,
wherein the first reference member is fixed to a first surface of the transparent glass,
wherein the second reference member is fixed to a second surface which is different from the first surface of the transparent glass, and
wherein the second reference member is situated on an opposite side of the transparent member with respect to the second sensor.

3. The document reading apparatus according to claim 2, wherein the first reading position and the second reading position are located on the transparent member, and
wherein in a direction in which the document is conveyed, the first reading position is situated upstream of the second reading position.

4. The document reading apparatus according to claim 1, wherein the profile data contains data corresponding to a plurality of different positions in a main-scanning direction which is orthogonal to a direction in which the document is conveyed.

5. The document reading apparatus according to claim 1, wherein the profile data is data indicating a ratio between third measurement data acquired by the second sensor by reading a third reference member placed on the second reading position and the second measurement data.

6. The document reading apparatus according to claim 1, wherein the storage unit stores verification data for verification of the profile data, and
wherein the verification unit verifies the profile data using the verification data.

7. The document reading apparatus according to claim 6, wherein the verification data is a checksum.

8. The document reading apparatus according to claim 1, wherein the verification unit judges whether the profile data is within a predetermined range.

9. The document reading apparatus according to claim 1, further comprising a document glass platen,
wherein the first sensor is movable under the document glass platen,
wherein the second sensor is immovable,
wherein the first sensor reads a document placed on the document glass platen while moving under the document glass platen, and
wherein the first sensor is moved to a position below the first reference member to read the first reference member.
